(19) United States
(12) Patent Application Publication
(10) Pub. No.: US 2013/0002627 A1
(43) Pub. Date: Jan. 3, 2013

(54) Gate Driver and Display Apparatus Using the Same

(76) Inventor: Tse-Hung Wu, New Taipei City (TW)

(21) Appl. No.: 13/293,133

(22) Filed: Nov. 10, 2011

(30) Foreign Application Priority Data
Jul. 1, 2011 (TW) 100123416

(51) Int. Cl. G09G 5/00

(52) U.S. Cl. 345/208; 345/211

(57) ABSTRACT

A gate driver includes a gate driving logic circuit for generating a plurality of switch signals, a plurality of output modules each including a modulation circuit for responding to one of the plurality of switch signals to generate an intermediate signal at an intermediate terminal, a buffer for responding to the intermediate signal to generate a gate driving signal at an output terminal, and a modulation switch for determining an electric connection between the intermediate terminal and the output terminal. The modulation switch is turned on during a modulation period of the gate driving signal to modulate a waveform of the gate driving signal.

### BACKGROUND OF THE INVENTION

1. Field of the Invention

The present invention relates to a gate driver and a display apparatus using the same, and more particularly, to a gate driver and a display apparatus modulating a waveform of the gate driving signal by providing a discharging path.

2. Description of the Prior Art

A liquid crystal display (LCD) has advantages of light weight, low power consumption, low radiation contamination, etc., and is widely used in various information products, such as computer systems, cell phones, personal digital assistants (PDAs), etc. In an LCD monitor, incident light produces different polarization or refraction effects when the alignment of liquid crystal molecules is altered. Thus, the alignment of the liquid crystal molecules is utilized to control the light transmittance, and produce lights with different intensities and colors, such as red, green and blue lights.

Please refer to FIG. 1, which illustrates a schematic diagram of a conventional thin film transistor (TFT) LCD apparatus 10. The LCD apparatus 10 includes an LCD panel 100, a source driver 102, a gate driver 104 and a voltage generator 106. The LCD panel 100 includes two substrates, and an LCD layer is filled between these two substrates. One substrate is disposed with a plurality of data lines 108, a plurality of scan lines (gate lines) 110 perpendicular to the data lines 108, and a plurality of TFTs 112, while the other substrate is disposed with a common electrode for providing a common voltage Vcom generated by the voltage generator 106. The TFTs 112 are disposed on the LCD panel 100 in matrix. Each data line 108 is corresponding to a column of the LCD panel 100, each scan line 110 is corresponding to a row of the LCD panel 100, and each TFT 112 is corresponding to a pixel. Besides, circuit characteristics of the two substrates of the LCD panel 100 can be seen as an equivalent capacitor 114.

In FIG. 1, the gate driver 104 sequentially generates gate driving signals VG_1-VG_M for turning on each row of the plurality of TFTs 112, so as to refresh pixel data stored in the equivalent capacitors 114. In detail, please refer to FIG. 2, which illustrates a schematic diagram of the gate driver 104. The gate driver 104 includes a logic circuit 105 and buffers 107_1-107_M. Load modules 109_1-109_M are equivalent circuits of each loads. The logic circuit 105 controls switches of transistors in the buffers 107_1-107_M, to connect the load modules 109_1-109_M to a high voltage source VGG and to a low voltage source VEE in turn, as square waves in the gate driving signals VG_1-VG_M.

However, due to parasitic capacitors existing between the equivalent capacitors 114 and the TFTs 112, when the square waves are located at the trailing edges of the gate driving signals VG_1-VG_M, voltage changes of the gate driving signals VG_1-VG_M are coupled to the equivalent capacitors 114 via the parasitic capacitors, such that offset images are stored in the equivalent capacitors 114. In order to improve coupling effects of the trailing edges, the gate driver 104 can re-arrange waveforms to adjust waveforms of the square waves in the gate driving signals VG_1-VG_M, as shown in FIG. 3, where the trailing edges of the gate driving signals VG_1-VG_M are modulated to avoid rapid changes of the gate driving signals VG_1-VG_M affecting the stored pixel data. Certainly, in order to generate the modulated waveforms shown in FIG. 3, the gate driver 104 must include additional control circuits.

Therefore, how to use an economical method to modulate the waveforms of the gate driver has become an important issue in the art.

### SUMMARY OF THE INVENTION

It is therefore an objective of the disclosure to provide a gate driver and a display apparatus using the same.

In one aspect, a gate driver is disclosed, comprising a gate driving logic circuit for generating a plurality of switch signals, and a plurality of output modules, each comprising a modulation circuit, coupled between a first power supply and a second power supply, for responding to one of the plurality of switch signals, to generate an intermediate signal at an intermediate terminal, a buffer, coupled between the first power supply and the second power supply, for responding to the intermediate signal to generate a gate driving signal at an output terminal, and a modulation switch, coupled between the output terminal and the intermediate terminal, for controlling an electric connection between the output terminal and the intermediate terminal, wherein the modulation switch is turned on during a modulation period of the gate driving signal.

In another aspect, a display apparatus is further disclosed, comprising the gate driver and a panel, for receiving controls of the gate driver to display images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional thin film transistor (TFT) LCD apparatus.

FIG. 2 illustrates a schematic diagram of a gate driver of the TFT LCD apparatus shown in FIG. 1.

FIG. 3 illustrates a sequence diagram of a gate driving signal.

FIG. 4 illustrates a schematic diagram of a display apparatus according to the embodiment of the present invention.

FIG. 5A illustrates a schematic diagram of the gate driver shown in FIG. 4 according to an embodiment of the present invention.

FIG. 5B illustrates a schematic diagram of the gate driver shown in FIG. 4.

FIG. 5C illustrates an operating sequence diagram of a switch signal, a control signal of a breaking switch, a control signal of a modulation switch and the gate driving signal of any output module in the gate driver shown in FIG. 5B.

FIG. 5D illustrates a sequence diagram of related signals of the gate driver shown in FIG. 5A.

FIG. 6A illustrates a schematic diagram of an alternation embodiment of the gate driver shown in FIG. 5A.

FIG. 6B illustrates a sequence diagram of related signals of the gate driver shown in FIG. 6A.

FIG. 7A and FIG. 7B illustrate schematic diagrams of an alternation embodiment of the gate driver shown in FIG. 5A.

FIG. 8 illustrates a sequence diagram of related signals of the gate driver shown in FIG. 7A.

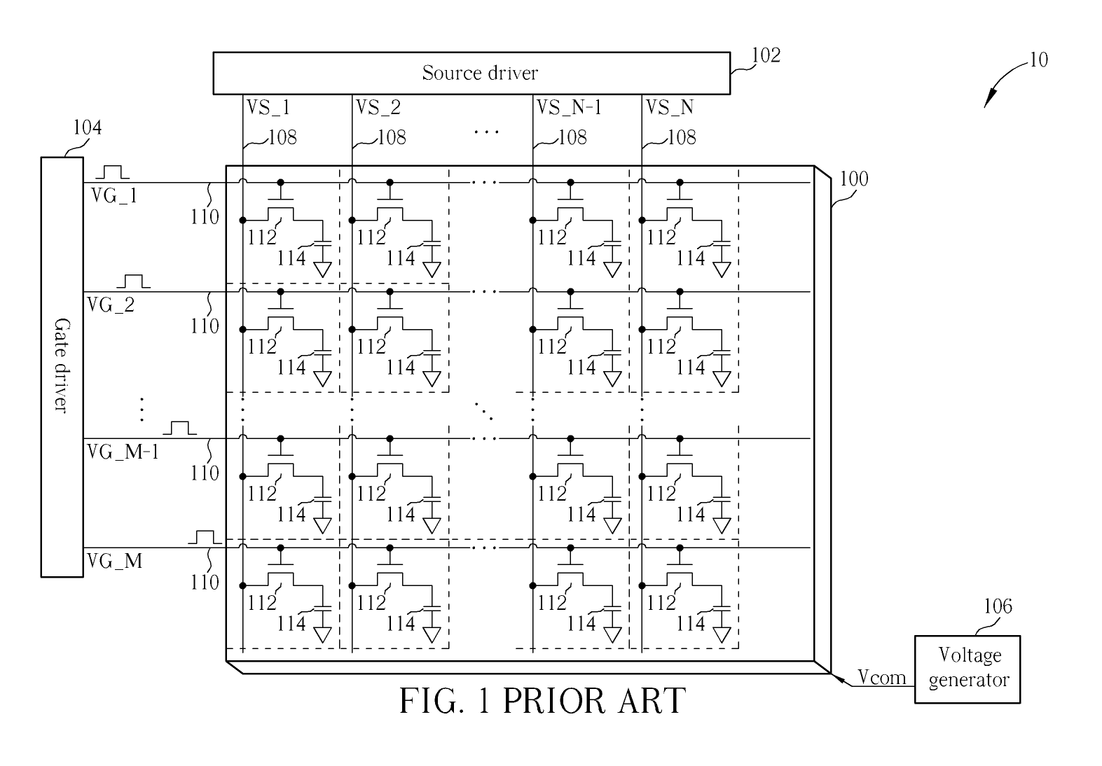

### DETAILED DESCRIPTION

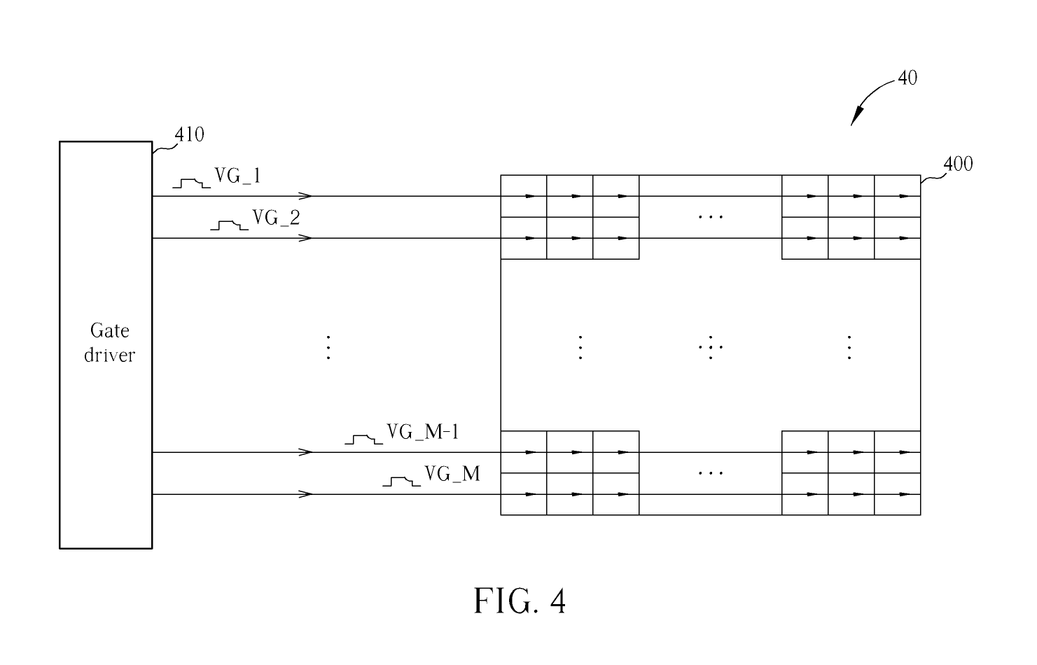

Please refer to FIG. 4, which illustrates a schematic diagram of a display apparatus 40 according to an embodiment of the present invention. The display apparatus 40 includes a panel 400 and a gate driver 410. The gate driver 410 is utilized to generate a plurality of gate driving signals VG_1-VG_M, to indicate sequences for updating display contents of pixels in each row of the panel 400. Since the gate driving signals VG_1-VG_M can scan thin film transistors (TFTs) of the panel 400 row by row, the gate driving signals VG_1-VG_M can sequentially carry square waves. Detailed description will show how the gate driving signals VG_1-VG_M are modulated to make trailing edges of each square wave gradually descend, thus having a cutting angle shape. After such modulating operation, coupling effects of the descending trailing edges of the gate driving signals VG_1-VG_M can be improved, to solve offset images.

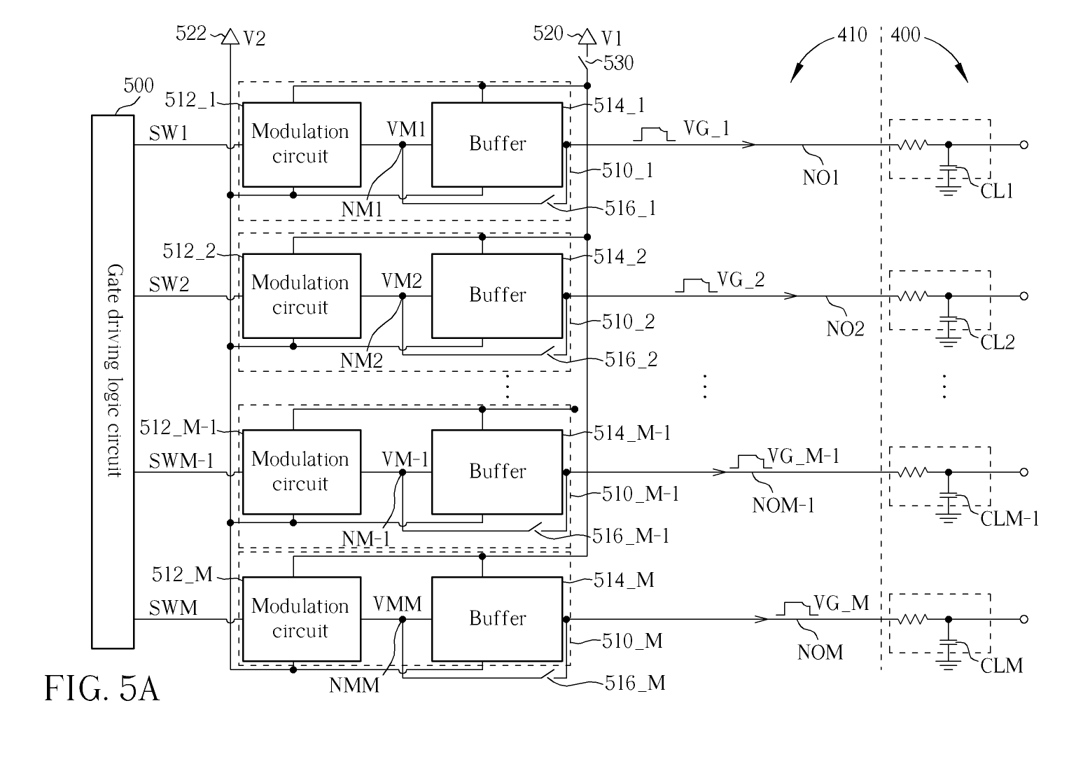

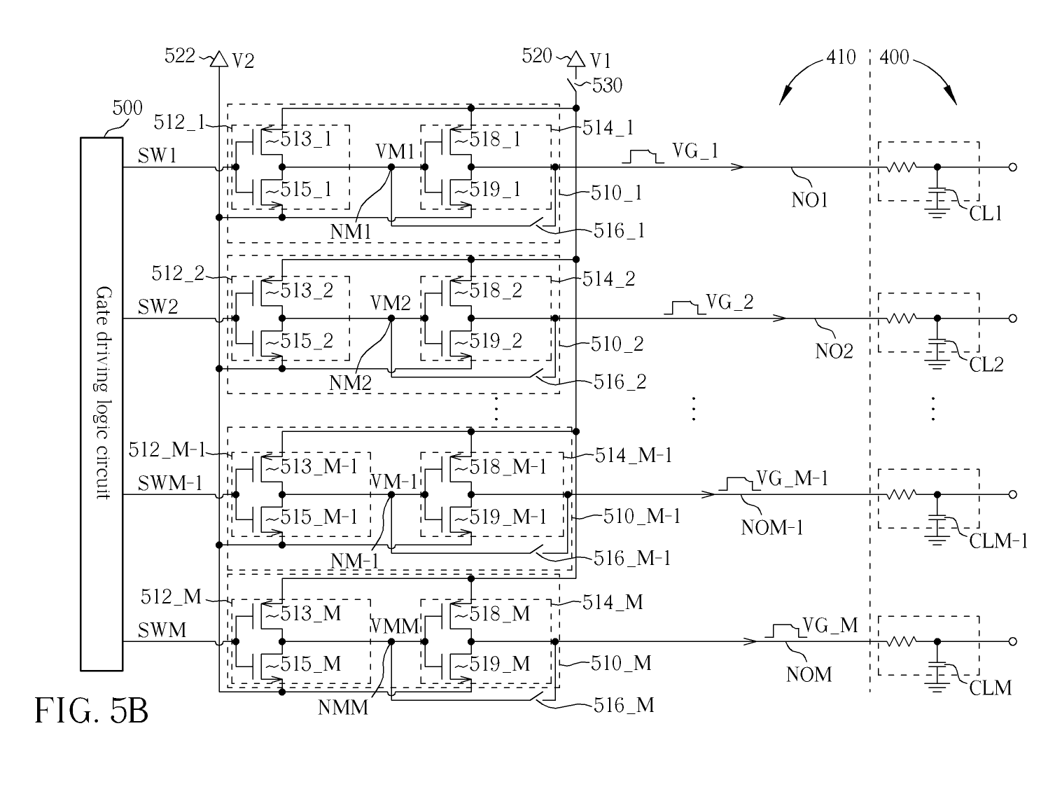

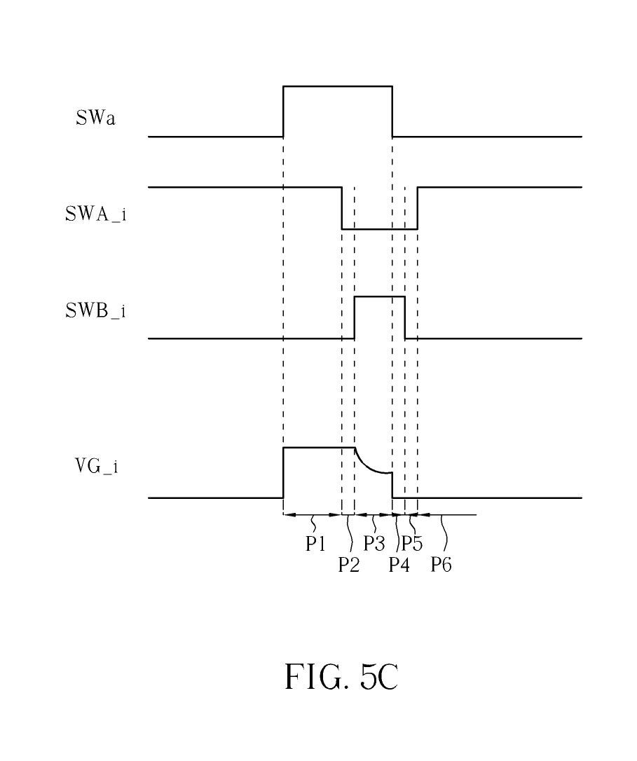

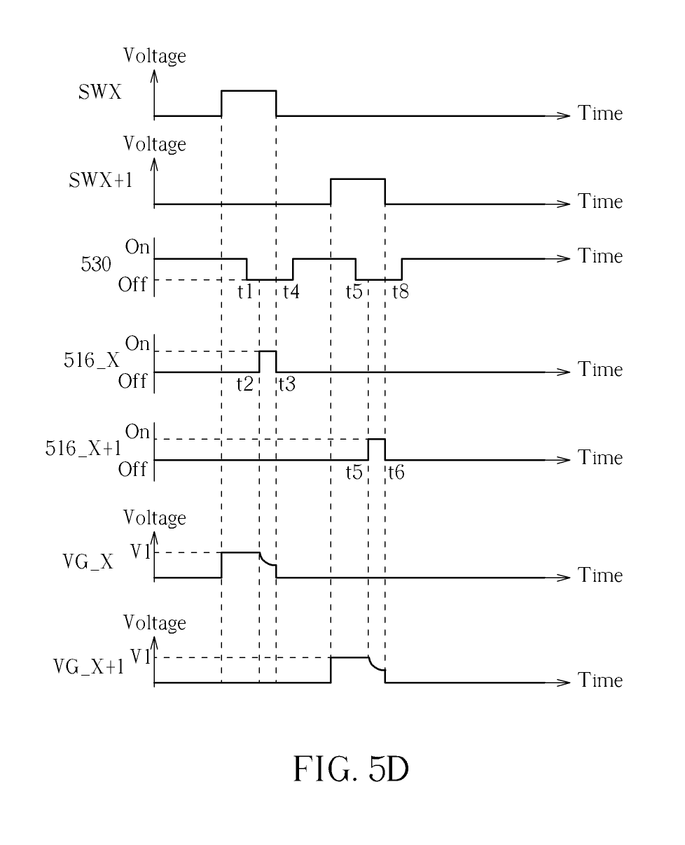

Please refer to FIG. 5A, which illustrates a schematic diagram of the gate driver 410 according to an embodiment of the present invention. The gate driver 410 includes a gate driving logic circuit 500 and output modules 510_1-510_M. The gate driving logic circuit 500 is utilized to generate switch signals SW1-SWM. The output modules 510_1-510_M include modulation circuits 512_1-512_M, buffers 514_1-514_M and modulation switches 516_1-516_M, respectively. The modulation circuits 512_1-512_M are utilized to respond to the switch signals SW1-SWM, respectively, to generate intermediate signals VM1-VM-1. The buffers 514_1-514_M are utilized to respond to the intermediate signals VM1-VM-1, respectively, to generate the gate driving signals VG_1-VG_M. The modulation switches 516_1-516_M are utilized to provide discharging paths between output terminals NO1-NOM and intermediate terminals NM1-NMM, respectively. Besides, the gate driver 410 further includes a breaking switch 530 coupled between a first power supply 520 and each of the output modules 510_1-510_M.

During a modulation period of each of the gate driving signals VG_1-VG_M, the corresponding modulation switches SW1-SWM are turned on, respectively, to couple the output terminals NO1-NOM to a second power supply 522 via the modulation circuits 512_1-512_M, so as to modulate waveforms of the gate driving signals VG_1-VG_M. Furthermore, during the modulation periods of the gate driving signals VG_1-VG_M, the breaking switch 530 simultaneously turns off power supply paths from the first power supply 520 to the modulation circuits 512_1-512_M and the buffers 514_1-514_M.

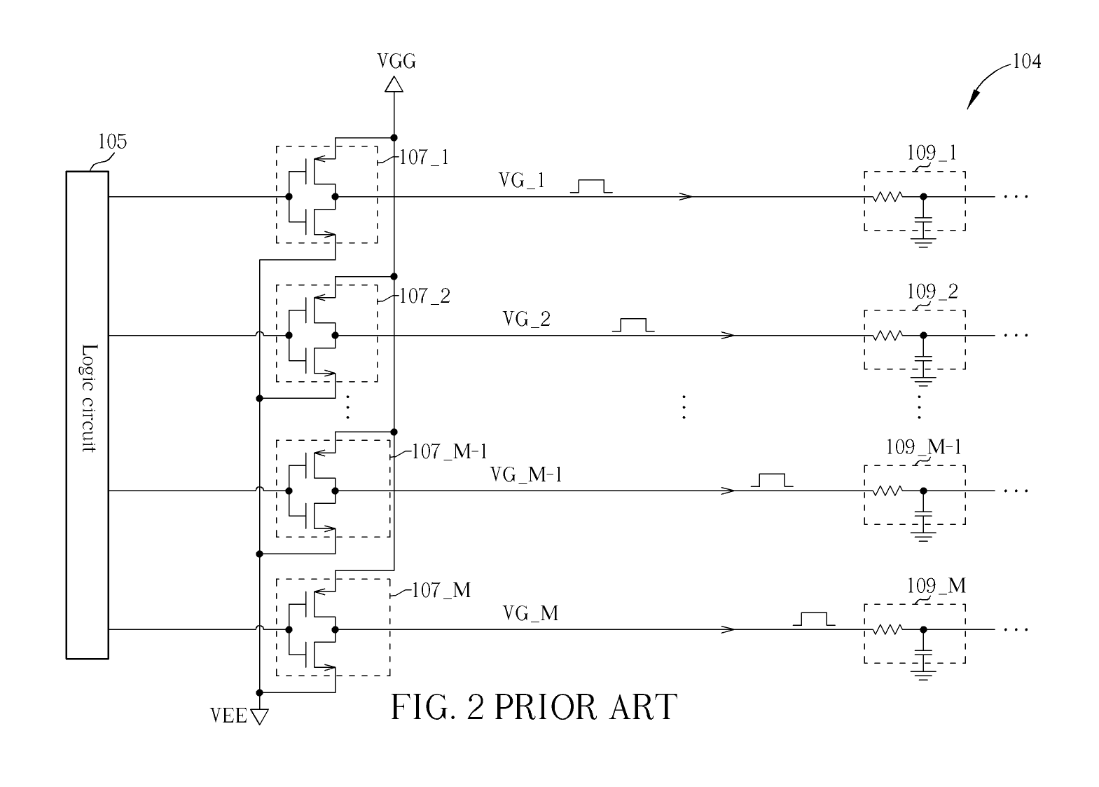

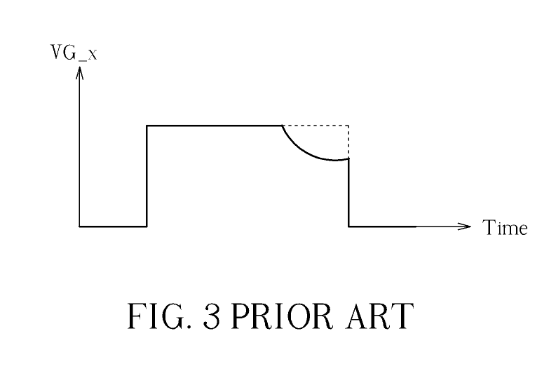

As can be seen, in comparison with the gate driver 104 shown in FIG. 2, the gate driver 410 additionally includes the modulation circuits 512_1-512_M and the modulation switches 516_1-516_M, to modulate the waveforms of the gate driving signals VG_1-VG_M. At the trailing edges of the square waves in the gate driving signals VG_1-VG_M, i.e. during the modulation periods, charges of load capacitors CL1-CLM in the panel 400 can discharge to the second power supply 522 via the modulation switches 516_1-516_M and the modulation circuits 512_1-512_M. Since such a discharging operation is a gradual process, the trailing edges of the square waves in the gate driving signals VG_1-VG_M can gradually change, so as to alleviate the coupling effects.

Please refer to FIG. 5B, which illustrates a schematic diagram of the gate driver 410, to show the detail circuit structure according to the modulation circuits 512_1-512_M and the output modules 510_1-510_M. Specifically, each of the modulation circuits 512_1-512_M includes a voltage pull-up block and a voltage pull-down block, such as first-type field effect transistors 513_1-513_M and second-type field effect transistors 515_1-515_M. The voltage pull-up block and the voltage pull-down block are controlled by the switch signals SW1-SWM, to output different voltage levels of the intermediate signals VM1-VMM, respectively.

Furthermore, in the embodiment shown in FIG. 5B, the modulation circuits 512_1-512_M have similar structures with the output modules 510_1-510_M. Each of the output modules 510_1-510_M includes a voltage pull-up block and a voltage pull-down block, such as first-type field effect transistors 518_1-518_M and second-type field effect transistors 519_1-519_M. The voltage pull-up block and the voltage pull-down block are controlled by the intermediate signals VM1-VMM, to output different voltage levels of the gate driving signals VG_1-VG_M, respectively. Noticeably, although the modulation circuits 512_1-512_M and the output modules 510_1-510_M have similar structures, the present invention is not limited thereto. Any available structure can be used to implement the modulation circuits 512_1-512_M as long as they are able to provide the discharging paths from the gate driving signals VG_1-VG_M to the second power supply 522 during the modulation period.

Please refer to FIG. 5C, which illustrates an operating sequence diagram of related signals of an arbitrary output module 510_{—}i (wherein i=1−M) in the gate driver 410 shown in FIG. 5B according to the embodiment of the present invention, which include a switch signal SWi, a control signal SWA_i of the breaking switch 530, a control signal SWB_i of a modulation switch 516_{—}i and a gate driving signal VG_i. As shown in FIG. 5C, at a period P1, the breaking switch 530 is turned on, the modulation switch 516_{—}i is turned off, the first-type field effect transistor 518_{—}i is turned on and the second-type field effect transistor 519_{—}i is turned off. At this moment, the first voltage V1 controlling the first power supply 520 is charging the gate driving signal VG_i, such that the gate driver 410 charges the i-th line of the panel 400. Next, at a period P2, the breaking switch 530 switches to off, the modulation switch 516_{—}i maintains off, the first-type field effect transistor 518_{—}i maintains on and the second-type field effect transistor 519_{—}i maintains off. At this moment, the breaking switch 530 can disconnect the first voltage V1 of the first power supply 520. Next, at a period P3, the breaking switch 530 maintains off, the modulation switch 516_{—}i switches to on, the first-type field effect transistor 518_{—}i is irrelevant and the second-type field effect transistor 519_{—}i maintains off. At this moment, the gate driving signal VG_i can be discharged by the modulation switch 516_{—}i and the second-type field effect transistor 515_{—}i, a conducting period of the modulation switch 516_{—}i can be able to simultaneously adjusted to modulate the output waveform.

Next, at a period P4, the breaking switch 530 maintains off, the modulation switch 516_{—}i switches to on, the first-type field effect transistor 518_{—}i is turned off and the second-type field effect transistor 519_{—}i switches on. Next, at a period P5, the breaking switch 530 maintains off, the modulation switch 516_{—}i switches to off, the first-type field effect transistor 518_{—}i maintains off and the second-type field effect transistor 519_{—}i maintains on. At this moment, the gate driving signal VG_i achieves a voltage level the same as the voltage level of the second power supply 522, to finish the output waveform modulation.

Next, at a period P6, the breaking switch 530 switches to on, the modulation switch 516_{—}i is turned off, the first-type field effect transistor 518_{—}i is turned off and the second-type field effect transistor 519_{—}i is turned on. At this moment, the first power supply 520 supplies the buffer 514_{—}i again, and the modulating operation continues as the sequence from the period P1 to the period P6, to finish the subsequent driving operation.

Noticeably, in order to isolate the first power supply 520, as long as any of the modulation switches 516_1-516_M is ready for modulation, the breaking switch 530 has to be disconnected accordingly. Because the breaking switch 530 is shared by the output modules 510_1-510_M, the breaking switch 530 has to be disconnected during the modulation period of each of the gate driving signals VG_1-VG_M. For example, please refer to FIG. 5D, which illustrates a sequence diagram of the switch signals SWX, SWX+1, the breaking switch 530, the modulation switches 516_X, 516_X+1 and the gate driving signals VG_X, VG_X+1 when modulating the gate driving signal VG_X, VG_X+1. The breaking switch 530 is disconnected at the period between t1 and t4 as well as at the period between t5 and t8, the modulation switch 516_X is disconnected at the period between t2 and t3, and the modulation switch 516_X+1 is disconnected at the period between t6 and t7. As a result, the gate driving signals VG_X and VG_X+1 gradually descend from the level of the first voltage V1 of the first power supply 520 at the period between t2 and t3 as well as the period between t6 and t7.

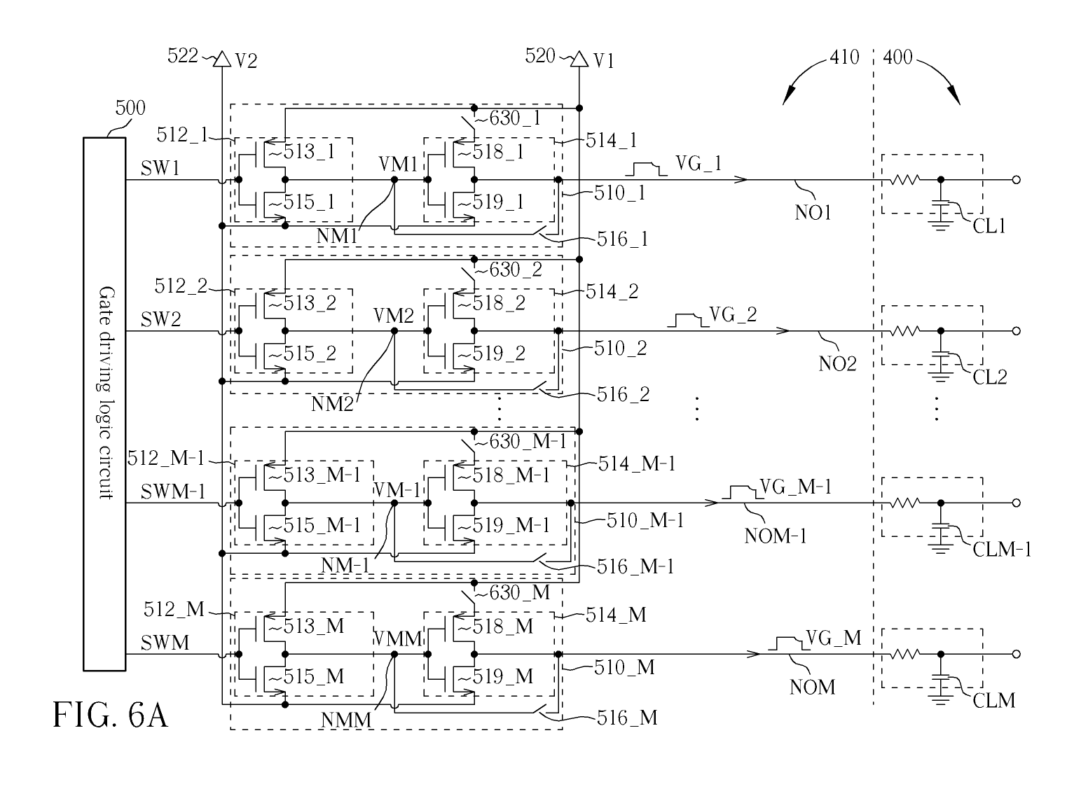

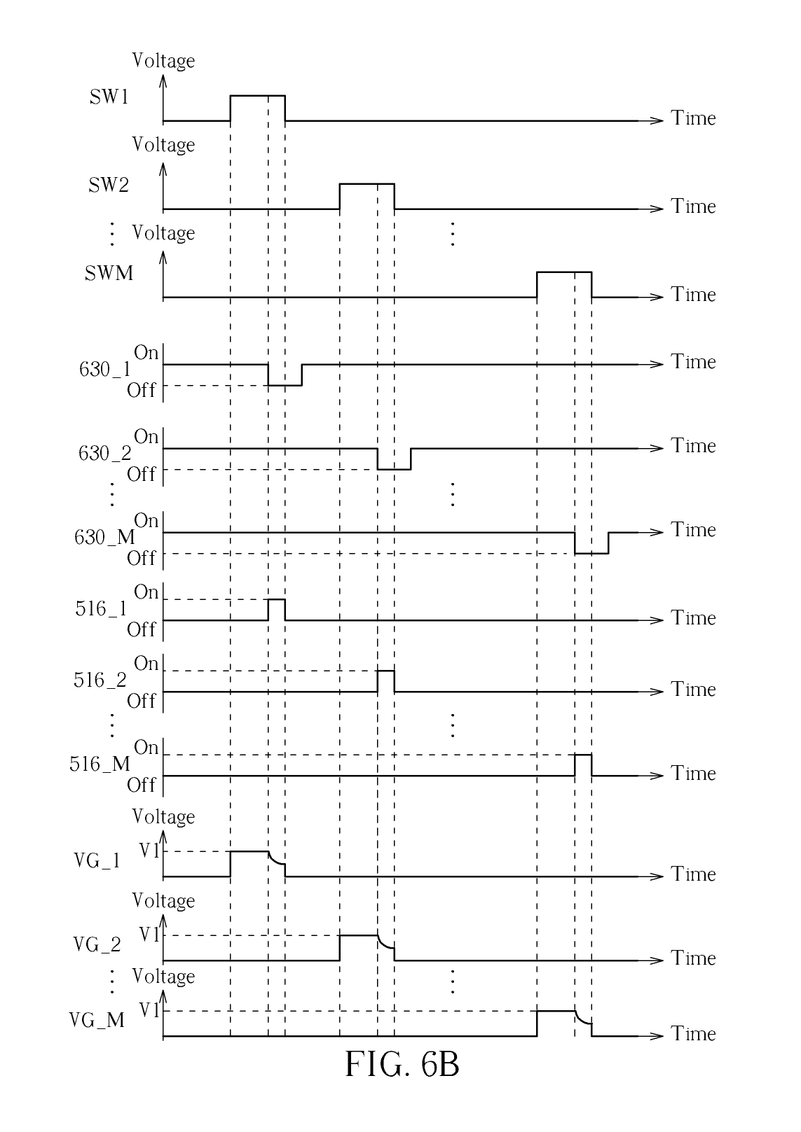

The breaking switch 530 shown in FIG. 5A is shared by the output modules 510_1-510_M, and the present invention is not limited thereto. In other embodiments, the output modules 510_1-510_M can include individual breaking switches 630_1-630_M, as shown in FIG. 6A. In such a circumstance, the breaking switches 630_1-630_M are sequentially disconnected at the corresponding modulation periods of the source driving signals VG_1-VG_M, i.e. during the turn-on periods of the modulation switches 516_1-516_M, as shown in FIG. 6B. Noticeably, the modulation switches 516_1-516_M, shown in either FIG. 5A or FIG. 6A, are controlled by the modulation signal generated by the gate driving logic circuit 500. The modulation signal is at a turn-on control mode at the corresponding modulation period of the gate driving signal, which is a well-known skill in the art, and is not narrated hereinafter.

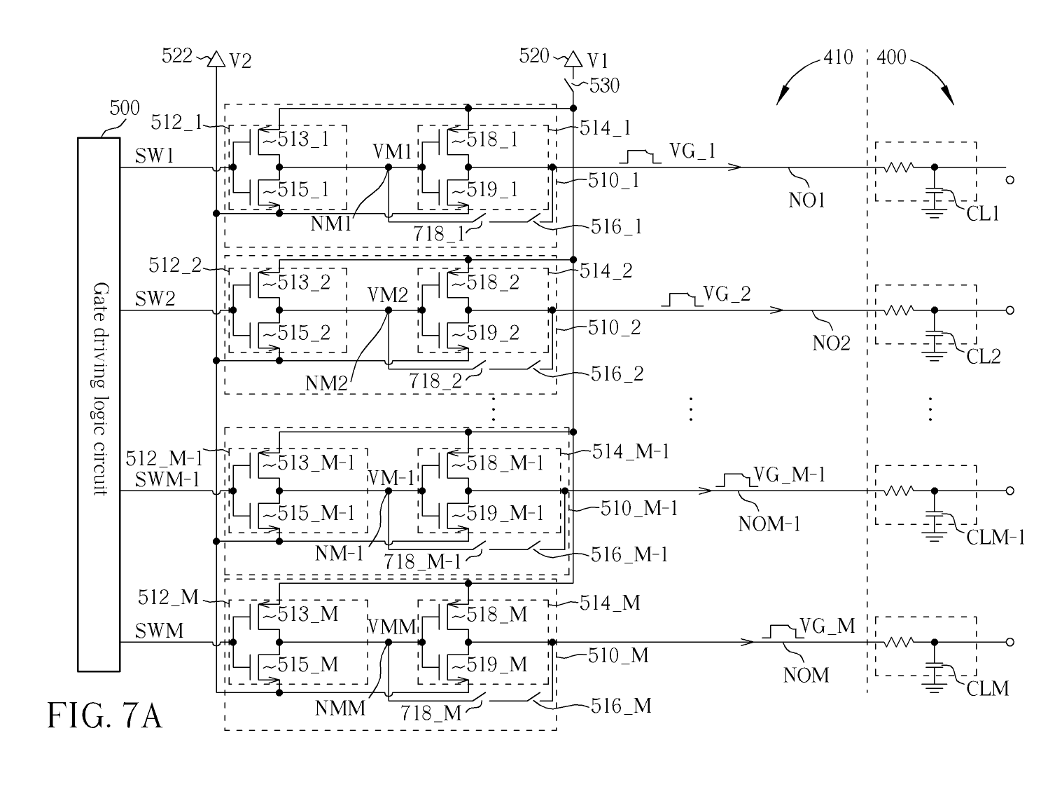

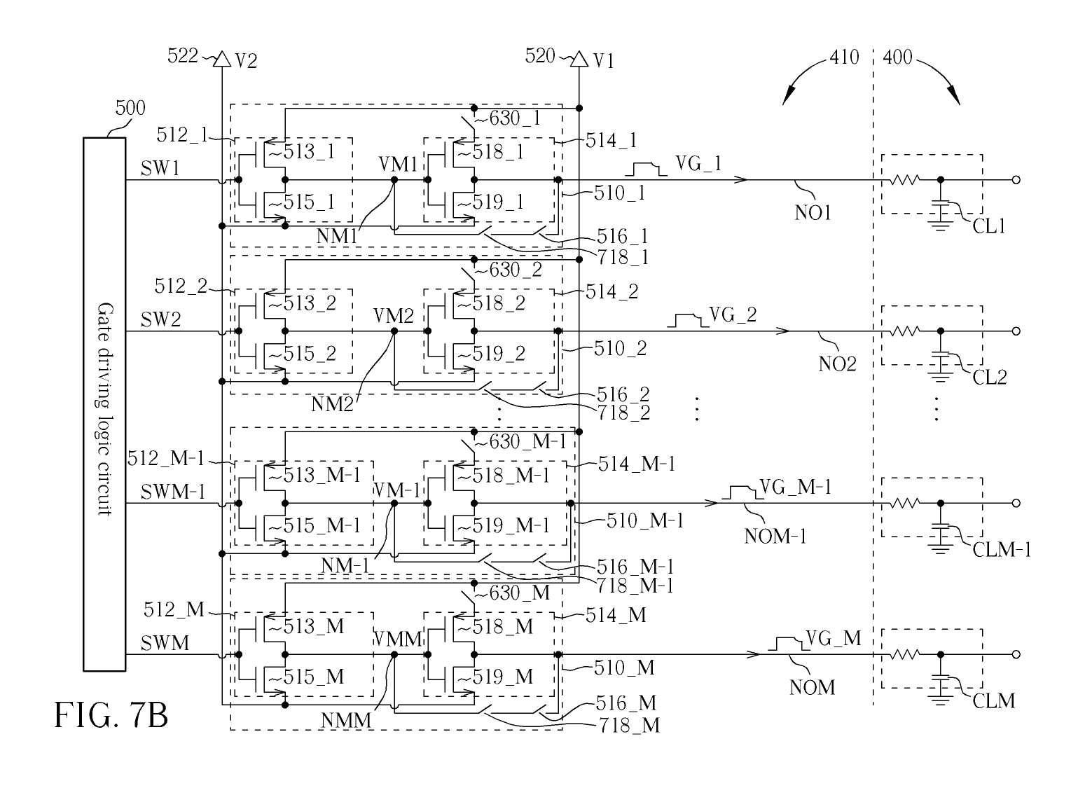

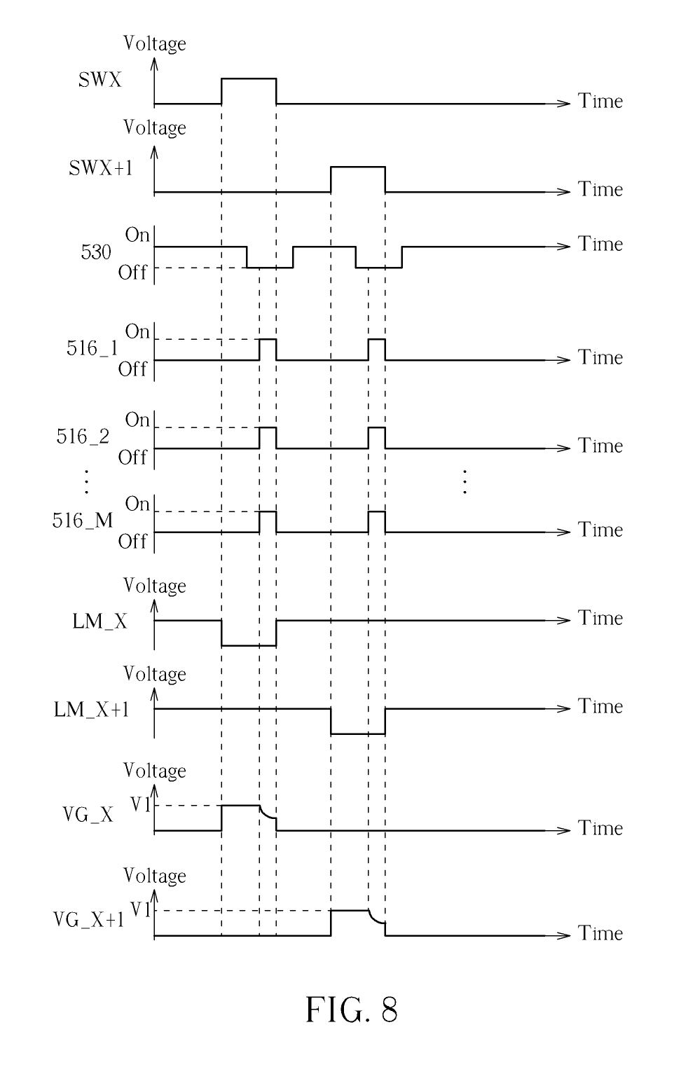

Moreover, the output modules 510_1-510_M, shown in FIG. 5A or in FIG. 6A, can further include local modulation switches 718_1-718_M, respectively, as shown in FIG. 7A and FIG. 7B. Preferably, the local modulation switches 718_1-718_M are controlled by the local modulation signals, respectively, and the local modulation signals can be inversion signals of the corresponding gate driving signals VG_1-VG_M. For example, when modulating the gate driving signals VG_X and VG_X+1, controls of the local modulation signals LM_X and LM_X+1 of the local modulation switches 718_X and 718_X+1 are the inversion phase signals of the gate driving signals VG_X and VG_X+1, as shown in FIG. 8. In such a circumstance, the modulation switches 516_1-516_M are control by an universal modulation signal. The universal modulation signal is at a turn-on controlled mode during all the modulation periods of the gate driving signals.

In the prior art, voltage changes of the gate driving signals VG_1-VG_M are coupled to the equivalent capacitors 114 via parasitic capacitors, making the equivalent capacitors 114 store the offset images, such that waveform re-arrangement is needed to alleviate the coupling effects. In comparison, the embodiments use switches to turn off the power supply at the trailing edges of the gate driving signals VG_1-VG_M, and provide a discharging path for the load capacitors CL1-CLM via the modulation circuits 510_1-510_M and the modulation switches 516_1-516_M, such that the gate driving signals VG_1-VG_M gradually descend to alleviate the coupling effects.

In summary, the embodiments can, on a premise that no additional complex control circuits are required, provide a discharging path for the load capacitors, so as to allow the trailing edge of the gate driving signal to descend gradually. Therefore, the embodiments can realize modulation in an economic and power-saving way.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gate driver comprising:
a gate driving logic circuit for generating a plurality of switch signals; and
a plurality of output modules, each comprising:
a modulation circuit, coupled between a first power supply and a second power supply, for responding to one of the plurality of switch signals, to generate an intermediate signal at an intermediate terminal;
a buffer, coupled between the first power supply and the second power supply, for responding to the intermediate signal to generate a gate driving signal at an output terminal; and
a modulation switch, coupled between the output terminal and the intermediate terminal, for controlling an electric connection between the output terminal and the intermediate terminal, wherein the modulation switch is turned on during a modulation period of the gate driving signal.

2. The gate driver of claim 1, wherein the modulation switch is utilized to connect the output terminal to the second power supply via the modulation circuit, to modulate a waveform of the gate driving signal.

3. The gate driver of claim 2, wherein the modulation period of the gate driving signal of each of the plurality of output modules is located at a trailing edge of a square wave of the gate driving signal.

4. The gate driver of claim 1, further comprising one or more breaking switches, each coupled between the first power supply and the buffer of each of one or more corresponding output modules in the plurality of output modules, and disconnecting the electric connection between the buffer and the first power supply during the modulation period of the gate driving signal corresponding to the one or more output modules, respectively.

5. The gate driver of claim 4, wherein each of the one or more breaking switches is further coupled between the first power supply and the modulation circuit of each of the one or more corresponding output modules in the plurality of output modules, and further disconnects the electric connection between the modulation circuit and the first power supply during the modulation period of the gate driving signal corresponding to the one or more output modules, respectively.

6. The gate driver of claim 1, wherein the modulation switch of each of the plurality of the output modules is controlled by one corresponding modulation signal of a plurality of modulation signals to be turned on or turned off, and the corresponding modulation signal is at a turn-on control mode during the modulation period of the gate driving signal of the output module.

7. The gate driver of claim 1, wherein at least one of the plurality of output modules further comprises a local modulation switch, connected in series with the modulation switch between the intermediate terminal and the output terminal, for receiving controls of a corresponding local modulation signal of a plurality of local modulation signals to be turned on or turned off.

8. The gate driver of claim 1, wherein the corresponding local modulation signal is an inversion signal of the gate driving signal of the output module.

9. The gate driver of claim 7, wherein the modulation switch of each of the plurality of output modules is controlled by a universal modulation signal, and the universal modulation signal is at a turn-on control mode during the modulation period of the gate driving signal of each of the plurality of output modules.

10. The gate driver of claim 1, wherein the buffer of each of the plurality of output modules comprises a voltage pull-up block and a voltage pull-down block, both connected in series between the first power supply and the second power supply, for receiving controls of the intermediate signal, and outputting different voltage levels of the gate driving signal.

11. The gate driver of claim 1, wherein the buffer of each of the plurality of output modules comprises a first-type field effect transistor and a second-type field effect transistor, connected in series between the first power supply and the second power supply, and gates of the first-type field effect transistor and the second-type field effect transistor connect to the intermediate signal.

12. The gate driver of claim 1, wherein the modulation circuit of each of the plurality of output modules comprises a voltage pull-up block and a voltage pull-down block, both connected in series between the first power supply and the second power supply, for receiving controls of the switch signal, and outputting different voltage levels of the intermediate signal.

13. The gate driver of claim 1, wherein the modulation circuit of each of the plurality of output modules comprises a first-type field effect transistor and a second-type field effect transistor, connected in series between the first power supply and the second power supply, and gates of the first-type field effect transistor and the second-type field effect transistor connect to the switch signals.

14. A display apparatus comprising the gate driver of claim 1 and a panel, for receiving controls of the gate driver to display images.
